(19) United States
(12) Patent Application Publication
(10) Pub. No.: US 2025/0016850 A1
(43) Pub. Date: Jan. 9, 2025

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/888,181

(22) Filed: Sep. 18, 2024

Related U.S. Application Data
(63) Continuation of application No. PCT/CN2023/082105, filed on Mar. 17, 2023.

(30) Foreign Application Priority Data
Mar. 21, 2022 (CN) 202210277124.9

(51) Int. Cl. H04W 76/10; H04W 28/18; H04W 76/27

(52) U.S. Cl. CPC H04W 76/10; H04W 28/18; H04W 76/27

(57) ABSTRACT

The present application discloses a method and a device for wireless communications, including transmitting a first message; the first message being used to indicate at least one of a capability of being in communication with a first network or a capability of being in communication with a network other than the first network; the first message being for the first network; and being in communication with a second network; where whether the first message is transmitted before the action of being in communication with the second network or is transmitted along with the action of being in communication with the second network is related to whether any condition in a first condition set is satisfied. By transmitting the first message, this application helps to optimize the network, improve the reliability of communication, and avoid communication interruption.

### CROSS REFERENCE TO RELATED APPLICATIONS

This application is the continuation of the international patent application No. PCT/CN2023/082105, filed on Mar. 17, 2023, and claims the priority benefit of Chinese Patent Application No. 202210277124.9, filed on Mar. 21, 2022, the full disclosure of which is incorporated herein by reference.

### BACKGROUND

### Technical Field

The present application relates to transmission methods and devices in wireless communication systems, in particular to a method and device for reducing traffic interruptions, improving QoS of traffics, and, in particular for simultaneous communications with multiple networks and the like.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non-Terrestrial Network (NTN) and Terrestrial Network (TN), Dual connectivity system, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The UE can be connected to the network either directly or via a relay connection.

As the number and complexity of system scenarios increases, more and more requests have been made on reducing interruption rate and latency; strengthening reliability and system stability, increasing the traffic flexibility and power conservation, and in the meantime the compatibility between different versions of systems shall be taken into account for system designing.

The 3GPP standardization organization has worked on 5G standardization to formulate a series of specifications, of which the details can refer to:
https://www.3gpp.org/ftp/Specs/archive/38_series/38.321/38321-g50.zip
https://www.3gpp.org/ftp/Specs/archive/38_series/38.331/38331-g60.zip

### SUMMARY

In various communication scenarios, when a UE (i.e., user equipment, or terminal/cellphone) needs to be in communication with multiple networks, particularly when using multiple corresponding SIMs, there arises a problem of coordination among the networks. When the UE's own hardcore is not sufficient enough to support its communication with two networks simultaneously, independently, in parallel and free from any influence, if a certain degree of coordination can be provided based on the network assistance or initiated by the UE itself, mutual influence between two networks can be avoided. For instance, when the UE needs communications with another network but the current network also indicates its data transmission or reception, especially via a large bandwidth or multiple cell groups, the two networks may be mutually influenced. Even if some UE may have two receivers and one or two transmitters, and may be able to receive or transmit signals from or to two networks simultaneously, each network cannot take up all the capabilities of this UE, e.g., it cannot occupy all the bandwidth, it cannot take up both transceivers, and the data throughput or processing capabilities of the two networks will be hampered by each other. The two SIMs or multiple SIMs of the UE may be provided by different operators, which makes the coordination among the networks very limited, so it is hard to coordinate only depending on the networks, and even worse, for the sake of privacy, it is necessary to avoid the leakage of private user information from one network to another. When the UE needs to communicate with another network, it can only ask for coordination from one or two of the networks separately, rather than mutual coordination between these networks. Then the UE's capabilities will be split or coordinated between two networks. On the other hand, the process and method of coordination shall take into account different situations; in some cases, it is necessary to coordinate with the current network, including sending requests, before communicating with the other network, while in some other cases, it is necessary or possible to communicate with the other network before coordinating with or notifying the current network. Therefore, how to communicate with two networks at the same time, especially how to minimize the latency and the mutual influence in simultaneous communication with two networks, and support various communication needs and scenarios is a problem that needs to be solved.

To address the problem presented above, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
transmitting a first message; the first message being used to indicate at least one of a capability of being in communication with a first network or a capability of being in communication with a network other than the first network; the first message being for the first network; and
being in communication with a second network;
herein, whether the first message is transmitted before the action of being in communication with the second network or is transmitted along with the action of being in communication with the second network is related to whether any condition in a first condition set is satisfied; the first condition set includes at least one of a first condition, a second condition or a third condition, the first condition being that the first node establishes no RRC connection with the first network, the second condition being that the first node transmits no capability information to the first network, and the third condition being that a capability indicated by the capability information transmitted to the first network from the first node does not include the capability of being in communication with the second network; the sentence whether the first message is transmitted before the action of being in communication with the second network or is transmitted along with the action of being in communication with the second network is related to whether any condition in a first condition set is satisfied, meaning: when any condition in the first condition set is satisfied, the first message is transmitted along with the action of being in communication with the second network; when none of conditions in the first condition set is satisfied, the first message is transmitted before the action of being in communication with the second network.

In one embodiment, a problem to be solved in the present application includes: how to utilize a measurement gap to support multi-SIM card communications.

In one embodiment, an advantage of the above method includes: better support for multi-SIM communications, improved efficiency; avoided interruption of communication, simplified system design, and reduced system complexity.

Specifically; according to one aspect of the present application, the first message is transmitted along with the action of being in communication with the second network, the action of being in the communication with the second network being used to trigger the first message.

Specifically, according to one aspect of the present application, whether the first message is used to indicate the capability of being in communication with the first network or the capability of being in communication with a network other than the first network is related to whether the first message is transmitted before the action of being in communication with the second network or is transmitted along with the action of being in communication with the second network; when the first message is transmitted before the action of being in communication with the second network, the first message indicates a capability required for communication with a network other than the first network; when the first message is transmitted along with the action of being in communication with the second network, the first message indicates the capability of being in communication with the first network.

Specifically, according to one aspect of the present application, the first message is used to indicate that the first node is in communication with a network other than the first network, that the first node is in communication with a network other than the first network indicated by the first message being used to indicate the capability of being in communication with a network other than the first network.

Specifically, according to one aspect of the present application, transmitting a first request message, the first request message being used to request capability update; and
receiving a first capability enquiry message after the first request message is transmitted;
herein, the first capability enquiry message is used to trigger the first message.

Specifically, according to one aspect of the present application, receiving a first capability enquiry message after the first message is transmitted;
transmitting a second message as a response to receiving the first capability enquiry message;
herein, the first message is used to indicate the capability of being in communication with the second network, while the second message is used to indicate the capability of being in communication with the first network.

Specifically, according to one aspect of the present application, the first message is used to request no use of capability/capabilities in a first capability set, the first capability set including at least one capability, the capability of being in communication with the second network including the first capability set.

Specifically, according to one aspect of the present application, receiving a first acknowledgment message; the first acknowledgment message being used to approve the first message;
herein, the first message is transmitted before the action of being in communication with the second network, and reception of the first acknowledgment message is earlier than the action of being in communication with the second network.

Specifically, according to one aspect of the present application, stopping the communication with the second network;
transmitting a third message as a response to the action of stopping the communication with the second network, the third message being used to request the use of the capability/capabilities in a first capability set.

In one embodiment, along with the first message, starting a first timer, and upon reception of an acknowledgment message for the first message, stopping the first timer.

In one subembodiment, the first message is transmitted only when the first timer is not running.

In one subembodiment, the first node suspends at least part of radio bearer(s) as a response to the first timer being expired.

In one subembodiment, the first node de-activates at least one serving cell or cell group as a response to the first timer being expired.

Specifically, according to one aspect of the present application, the first node is a terminal of Internet of Things (IoT).

Specifically, according to one aspect of the present application, the first node is a relay.

Specifically, according to one aspect of the present application, the first node is a U2N remote UE.

Specifically, according to one aspect of the present application, the first node is a vehicle-mounted terminal.

Specifically, according to one aspect of the present application, the first node is an aircraft.

Specifically, according to one aspect of the present application, the first node is a cellphone.

Specifically, according to one aspect of the present application, the first node is a communication terminal supporting multi-SIM communications.

The present application provides a first node for wireless communications, comprising:
a first transmitter, transmitting a first message; the first message being used to indicate at least one of a capability of being in communication with a first network or a capability of being in communication with a network other than the first network; the first message being for the first network; and
a first processor, being in communication with a second network;
herein, whether the first message is transmitted before the action of being in communication with the second network or is transmitted along with the action of being in communication with the second network is related to whether any condition in a first condition set is satisfied; the first condition set includes at least one of a first condition, a second condition or a third condition, the first condition being that the first node establishes no RRC connection with the first network, the second condition being that the first node transmits no capability information to the first network, and the third condition being that a capability indicated by the capability information transmitted to the first network from the first node does not include the capability of being in communication with the second network; the sentence whether the first message is transmitted before the action of being in communication with the second network or is transmitted along with the action of being in communication with the second network is related to whether any condition in a first condition set is satisfied, meaning: when any condition in the first condition set is satisfied, the first message is transmitted along with the action of being in communication with the second network; when none of conditions in the first condition set is satisfied, the first message is transmitted before the action of being in communication with the second network.

In one embodiment, compared with the prior art, the present application is advantageous in the following aspects:

First, the method presented in this application can support communication with two networks simultaneously. First, the method proposed in this application can prevent the UE from being unable to perform communication with the other network due to its communication with one network in a scenario where two networks are connected to the UE. Furthermore, the method proposed in this application is not very complex, and is convenient and reliable for UE implementation, thus ensuring that the UE can communicate with the other network when necessary, without having to suspend or leave the current network. Furthermore, the method proposed in this application better supports multi-SIM UE.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmitting a first message and communicating with a second network according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to one embodiment of the present application.

FIG. 7 illustrates a schematic diagram of the capabilities for a first network and a second network according to one embodiment of the present application.

FIG. 8 illustrates a schematic diagram of the capabilities for a first network and a second network according to one embodiment of the present application.

FIG. 9 illustrates a schematic diagram of a first message being used to indicate a first node in communication with a network other than a first network according to one embodiment of the present application.

FIG. 10 illustrates a schematic diagram of a first message being used to indicate a capability of being in communication with a second network according to one embodiment of the present application.

FIG. 11 illustrates a schematic diagram of a second message being used to indicate a capability of being in communication with a first network according to one embodiment of the present application.

FIG. 12 illustrates a schematic diagram of a third message being used to request usage of capability/capabilities in a first capability set according to one embodiment of the present application.

FIG. 13 illustrates a structure block diagram of a processing device in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

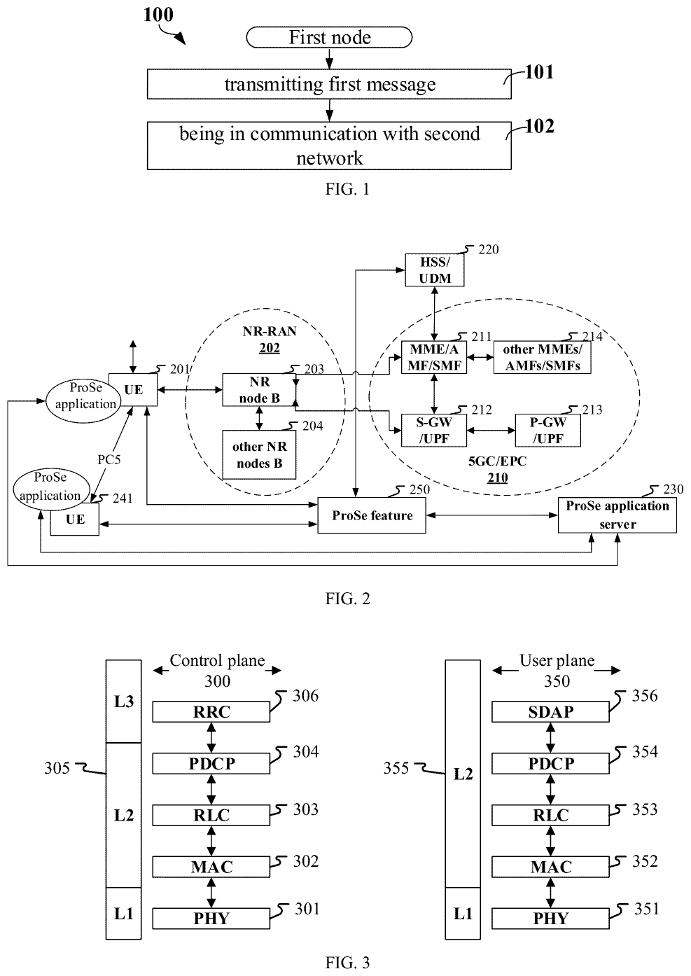

Embodiment 1 illustrates a flowchart of transmitting a first message and communicating with a second network according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application transmits a first message in step 101 and is in communication with a second network in step 102;
herein, the first message is used to indicate at least one of a capability of being in communication with a first network or a capability of being in communication with a network other than the first network; the first message being for the first network; whether the first message is transmitted before the action of being in communication with the second network or is transmitted along with the action of being in communication with the second network is related to whether any condition in a first condition set is satisfied; the first condition set includes at least one of a first condition, a second condition or a third condition, the first condition being that the first node establishes no RRC connection with the first network, the second condition being that the first node transmits no capability information to the first network, and the third condition being that a capability indicated by the capability information transmitted to the first network from the first node does not include the capability of being in communication with the second network; the sentence whether the first message is transmitted before the action of being in communication with the second network or is transmitted along with the action of being in communication with the second network is related to whether any condition in a first condition set is satisfied, meaning: when any condition in the first condition set is satisfied, the first message is transmitted along with the action of being in communication with the second network; when none of conditions in the first condition set is satisfied, the first message is transmitted before the action of being in communication with the second network.

In one embodiment, the first node is a User Equipment (UE).

In one embodiment, the first node has two SIMs that respectively correspond to two networks.

In one subembodiment, the two networks are respectively an LTE network and an NR network;

In one subembodiment, the two networks are respectively an NR network and another NR network;

In one subembodiment, the two networks are respectively a non-3GPP network and a 3GPP network;

In one subembodiment, the two networks are respectively a V2X network and an NR network.

In one embodiment, the first node has two SIMs, of which one SIM is for the first network and the other SIM is for the second network.

In one embodiment, the first node has two SIMs, and the first network and the second network are different Public Land Mobile Networks (PLMNs).

In one embodiment, the SIM comprises a Universal Subscriber Identity Module (USIM).

In one embodiment, the SIM comprises an eSIM.

In one embodiment, the SIM comprises a Universal Integrated Circuit Card (UICC).

In one embodiment, the SIM comprises a variety of sizes.

In one embodiment, the SIM comprises a virtual SIM.

In one embodiment, the SIM is for at least one of {LTE network, 3G network, 4G network, 5G network, 6G network, TN, NTN, URLLC network, IoT network, vehicle-mounted network, IIOT network, broadcast network, unicast network, 3GPP network, Non-3GPP network}.

In one embodiment, the first node has one transmitter and one receiver.

In one embodiment, the first node has one transmitter and two receivers.

In one embodiment, the first node has two transmitters and two receivers.

In one embodiment, the first node has an RRC connection with the first network when transmitting the first message.

In one embodiment, the first node has no RRC connection with the first network before transmitting the first message.

In one embodiment, the first node is in RRC Connected state relative to the first network.

In one embodiment, the first node is in RRC Connected state relative to the second network.

In one embodiment, the first node is in RRC Idle state relative to the second network.

In one embodiment, the first node is in RRC Inactive state relative to the second network.

In one embodiment, the first node supports interBandContiguousMRDC.

In one embodiment, the first node supports intraBandENDC-Support.

In one embodiment, the first node supports uplinkTxSwitching-OptionSupport-r16 for dualUL.

In one embodiment, the first node supports uplinkTxSwitching-OptionSupport-r16 for switchedUL.

In one embodiment, the first node supports MRDC.

In one embodiment, the first node supports NRDC.

In one embodiment, the first node is in RRC Connected state relative to a first network.

In one embodiment, the first node is in RRC Connected state relative to a second network.

In one embodiment, the first node is in RRC connected state before transmitting the first message.

In one embodiment, the following concepts have the same meaning: RRC_Connected state, RRC connected mode, being in RRC connected state, having an RRC connection, being in RRC_Connected state, RRC connected state, RRC_CONNECTED.

In one embodiment, the first node supports SCG.

In one embodiment, the first node is configured to support SCG.

In one embodiment, the first node is configured with an SCG when transmitting the first message.

In one embodiment, being configured with an SCG is one of trigger conditions for transmitting the first message.

In one embodiment, the first network is an NR network.

In one embodiment, the second network is an NR network.

In one embodiment, the second network is an eUTRA network.

In one embodiment, the first network is different from the second network.

In one embodiment, the first network uses a different radio access technology than the second network.

In one embodiment, the first message is or comprises an RRC message.

In one embodiment, the first message comprises assistance information.

In one embodiment, the first message is a UEAssistanceInformation message.

In one embodiment, the first message is a ulInformation Transfer message.

In one embodiment, the first message is a ueCapability Information message.

In one embodiment, the first message is a ulInformation TransferMRDC message.

In one embodiment, a name of the first message includes musim.

In one embodiment, the first message comprises part of fields of an RRC message.

In one embodiment, the first message occupies SRB1.

In one embodiment, the first message occupies a physical uplink shared channel (PUSCH).

In one embodiment, the first message is directly transmitted to the first network.

In one embodiment, the first message is transmitted to the first network via an L2 U2N relay:

In one embodiment, the capability of being in the communication with the first network includes at least one capability-related parameter.

In one embodiment, the capability of being in the communication with the first network includes a list of capabilities.

In one embodiment, the capability of being in the communication with the first network includes a frequency being supported.

In one embodiment, the capability of being in the communication with the first network includes whether NR-DC is supported.

In one embodiment, the capability of being in the communication with the first network includes whether CA-DC is supported.

In one embodiment, the capability of being in the communication with the first network includes whether multi-carrier is supported.

In one embodiment, the capability of being in the communication with the first network includes whether an SCell is supported and/or how many SCells are supported.

In one embodiment, the capability of being in the communication with the first network includes whether Dual Connectivity is supported.

In one embodiment, the capability of being in the communication with the first network includes whether relay is supported.

In one embodiment, the capability of being in the communication with the first network includes a processing capability of a physical layer.

In one embodiment, the capability of being in the communication with the first network includes a radio frequency (RF) capability.

In one embodiment, the capability of being in the communication with the first network includes a baseband capability.

In one embodiment, the capability of being in the communication with the first network includes a protocol being supported.

In one embodiment, the capability of being in the communication with the first network includes an antenna configuration.

In one embodiment, the capability of being in the communication with the first network includes a number of receiver(s) and/or transmitter(s).

In one embodiment, the capability of being in the communication with the first network includes whether multi-SIM communication is supported.

In one embodiment, the capability of being in the communication with the first network includes a wireless access technology being supported.

In one embodiment, the second network is a network other than the first network.

In one embodiment, the capability of being in the communication with a network other than the first network includes at least one capability-related parameter.

In one embodiment, the capability of being in the communication with a network other than the first network includes a list of capabilities.

In one embodiment, the capability of being in the communication with a network other than the first network includes a frequency being supported.

In one embodiment, the capability of being in the communication with a network other than the first network includes whether NR-DC is supported.

In one embodiment, the capability of being in the communication with a network other than the first network includes whether CA-DC is supported.

In one embodiment, the capability of being in the communication with a network other than the first network includes whether multi-carrier is supported.

In one embodiment, the capability of being in the communication with a network other than the first network includes whether an SCell is supported and/or how many SCells are supported.

In one embodiment, the capability of being in the communication with a network other than the first network includes whether Dual Connectivity is supported.

In one embodiment, the capability of being in the communication with a network other than the first network includes whether relay is supported.

In one embodiment, the capability of being in the communication with a network other than the first network includes a processing capability of a physical layer.

In one embodiment, the capability of being in the communication with a network other than the first network includes a radio frequency (RF) capability.

In one embodiment, the capability of being in the communication with a network other than the first network includes a baseband capability.

In one embodiment, the capability of being in the communication with a network other than the first network includes a protocol being supported.

In one embodiment, the capability of being in the communication with a network other than the first network includes an antenna configuration.

In one embodiment, the capability of being in the communication with a network other than the first network includes a number of receiver(s) and/or transmitter(s).

In one embodiment, the capability of being in the communication with a network other than the first network includes whether multi-SIM communication is supported.

In one embodiment, the capability of being in the communication with a network other than the first network includes a wireless access technology being supported.

In one embodiment, the first message reports the capability of being in communication with the first network via a container.

In one embodiment, the first message reports the capability of being in communication with a network other than the first network via a container.

In one embodiment, the first message is used to indicate a capability of being in communication with a first network or a capability of being in communication with a network other than the first network.

In one embodiment, the first message comprises a whole set of capabilities of the first node and its capability of being in communication with the first network.

In one subembodiment, the capability of being in communication with a network other than the first network is a capability other than the capability of being in communication with the first network in the whole set of capabilities of the first node.

In one embodiment, the first message comprises a whole set of capabilities of the first node and its capability of being in communication with a network other than the first network

In one subembodiment, the capability of being in communication with the first network is a capability other than the capability of being in communication with a network other than the first network in the whole set of capabilities of the first node.

In one embodiment, the first message comprises a set of capabilities of the first node, the set of capabilities including a whole set of communication capabilities of the first node, including a RF capability and a baseband capability, a capability of being in communication with the first network is a subset of the set of capabilities, and a capability of being in communication with a network other than the first network is a subset of the set of capabilities; the union of the capability of being in communication with the first network and the capability of being in communication with a network other than the first network is the set of capabilities.

In one embodiment, the first node supports communications with two cell groups simultaneously, the first message indicating the capability of being in communication with the first network as supporting only one cell group.

In one embodiment, the first node supports communications with two cell groups simultaneously; the first message indicating the capability of being in communication with a network other than the first network as supporting only one cell group.

In one embodiment, the first node supports a first frequency set and a second frequency set, the first frequency set and the second frequency set each comprising at least one frequency, the first message indicating the capability of being in communication with the first network as supporting only the first frequency set.

In one embodiment, the first node supports a first frequency set and a second frequency set, the first frequency set and the second frequency set each comprising at least one frequency, the first message indicating the capability of being in communication with a network other than the first network as supporting only the second frequency set.

In one embodiment, the first node supports a buffer size of A+B, and the first message indicates the capability of being in communication with the first network as supporting a buffer size of A.

In one embodiment, the first node supports a buffer size of A+B, and the first message indicates the capability of being in communication with a network other than the first network as supporting a buffer size of B.

In one embodiment, the number of receivers supported by the first node is X, where X is a positive integer greater than 1, and the first message indicates that the capability of being in communication with the first network is that the number of receiver(s) being supported is X1, where X1 is a positive integer less than X.

In one embodiment, the number of receivers supported by the first node is X, where X is a positive integer greater than 1, and the first message indicates that the capability of being in communication with a network other than the first network is that the number of receiver(s) being supported is X2, where X2 is a positive integer less than X.

In one embodiment, the number of transmitters supported by the first node is Y, where Y is a positive integer greater than 1, and the first message indicates that the capability of being in communication with the first network is that the number of transmitter(s) being supported is Y1, where Y1 is a positive integer less than Y.

In one embodiment, the number of transmitters supported by the first node is Y, where Y is a positive integer greater than 1, and the first message indicates that the capability of being in communication with a network other than the first network is that the number of transmitter(s) being supported is Y2, where Y2 is a positive integer less than Y.

In one embodiment, the first node supports one RB associated with N RLC entities, where N is a positive integer greater than 1, and the first message indicates the capability of being in communication with the first network as one RB being associated with N1 RLC entity/entities, where N1 is a positive integer less than N.

In one embodiment, the first node supports one RB associated with N RLC entities, where N is a positive integer greater than 1, and the first message indicates the capability of being in communication with a network other than the first network as one RB being associated with N2 RLC entity/entities, where N2 is a positive integer less than N.

In one embodiment, X1+X2=X, or, X1+X2>X.

In one embodiment, Y1+Y2=Y, or, Y1+Y2>Y.

In one embodiment, N1+N2=N, or, N1+N2>N.

In one embodiment, the meaning of the phrase the first message being for the first network is that the first message occupies resources of the first network.

In one embodiment, the meaning of the phrase the first message being for the first network is that the first message is scheduled by the first network.

In one embodiment, the meaning of the phrase the first message being for the first network is that the first message is transmitted using a radio bearer of the first node with the first network.

In one embodiment, the meaning of the phrase the first message being for the first network is that the first message is scrambled using a scrambling code assigned by the first network.

In one embodiment, the meaning of the phrase the first message being for the first network is that a transmission timing of the first message is determined according to the first network.

In one embodiment, the meaning of the phrase the first message being for the first network is that the first message uses a physical channel that is synchronized with the first network.

In one embodiment, the meaning of the phrase the first message being for the first network is that the first message is associated with an SSB transmitted by the first network.

In one embodiment, the meaning of the phrase the first message being for the first network is that an RRC connection is established between the first node and the first network, and an RRC entity corresponding to the RRC connection is the entity generating the first message.

In one embodiment, the meaning of the phrase the first message being for the first network is that the receiver of the first message is the first network.

In one embodiment, the action of being in communication with the second network comprises: at least transmitting a signal to the second network or receiving a signal from the second network.

In one embodiment, the action of being in communication with the second network comprises: establishing an RRC connection with the second network.

In one embodiment, the action of being in communication with the second network comprises: establishing a signaling bearer other than SRB0 with the second network.

In one embodiment, the action of being in communication with the second network comprises: establishing a DRB with the second network.

In one embodiment, the action of being in communication with the second network comprises: transmitting data to the second network or receiving data from the second network.

In one embodiment, the action of being in communication with the second network comprises: being synchronized with the second network.

In one embodiment, the action of being in communication with the second network comprises: accessing the second network, i.e. initiating a random access procedure for the second network.

In one embodiment, the action of being in communication with the second network comprises: transmitting a signal using resources indicated by the second network.

In one embodiment, the action of being in communication with the second network comprises: using a C-RNTI indicated by the second network.

In one embodiment, the action of being in communication with the second network comprises: monitoring a physical downlink Control Channel (PDCCH) of the second network.

In one subembodiment, monitoring a signal for the C-RNTI on the PDCCH.

In one embodiment, the action of being in communication with the second network comprises: transmitting a signal on a physical uplink Control Channel (PUCCH) configured by the second network.

In one embodiment, the action of being in communication with the second network comprises: exchanging information with the second network.

In one embodiment, the meaning of the phrase being transmitted along with the action of being in communication with the second network is or includes: transmitting the first message at the start of the action of being in communication with the second network.

In one embodiment, the meaning of the phrase being transmitted along with the action of being in communication with the second network is or includes: transmitting the first message at the same time as the action of being in communication with the second network.

In one embodiment, the meaning of the phrase being transmitted along with the action of being in communication with the second network is or includes: transmitting the first message after the start of the action of being in communication with the second network.

In one embodiment, the meaning of the phrase being transmitted along with the action of being in communication with the second network is or includes: the performance of the action of being in communication with the second network triggering transmission of the first message.

In one embodiment, the meaning of the phrase being transmitted along with the action of being in communication with the second network is or includes: transmitting the first message during the procedure of the action of being in communication with the second network.

In one embodiment, the meaning of the phrase being transmitted along with the action of being in communication with the second network is: the transmission of the first message is not before the action of being in communication with the second network.

In one embodiment, the meaning of the phrase being transmitted along with the action of being in communication with the second network is: firstly communicating with the second network and then transmitting the first message.

In one embodiment, when the first message is transmitted prior to the action of being in communication with the second network, the first message is used to request communication with a network other than the first network; when the first message is transmitted along with the action of being in communication with the second network, the first message is used to notify the first node of the communication with a network other than the first network.

In one embodiment, the first condition set comprises only one of the first condition, the second condition and the third condition.

In one embodiment, the first condition set only comprises any two of the first condition, the second condition and the third condition, for instance, comprising the first condition and the second condition, or comprising the first condition and the third condition, or comprising the second condition and the third condition.

In one embodiment, the first condition set comprises the first condition, the second condition and the third condition.

In one embodiment, the meaning of the sentence that the first node establishes no RRC connection with the first network comprises: the first node being in RRC idle state relative to the first network.

In one embodiment, the meaning of the sentence that the first node establishes no RRC connection with the first network comprises: the first node being in RRC inactive state relative to the first network.

In one embodiment, the meaning of the sentence that the first node establishes no RRC connection with the first network comprises that the action of being in communication with the second network occurs prior to establishing an RRC connection with the first network.

In one subembodiment, the transmitting of the first message occurs after the first node has established an RRC connection with the first network.

In one embodiment, the meaning of the sentence that the first node establishes no RRC connection with the first network comprises that the first node firstly establishes an RRC connection with the second network before establishing an RRC connection with the first network.

In one embodiment, the meaning of the sentence that the first node transmits no capability information to the first network comprises that the first node has established an RRC connection with the first network, but does not transmit capability information.

In one embodiment, the meaning of the sentence that the first node transmits no capability information to the first network comprises that the first node has established an RRC connection with the first network, but has not received a capability enquiry message.

In one embodiment, the meaning of the sentence that the first node transmits no capability information to the first network comprises that the first node has established an RRC connection with the first network, but has not yet transmitted any information for indicating a capability of being in communication with the first network.

In one embodiment, the meaning of the sentence that the first node transmits no capability information to the first network comprises that the first node has established an RRC connection with the first network, but has not yet transmitted any information for indicating a capability of being in communication with the second network.

In one embodiment, the meaning of the sentence that the first node transmits no capability information to the first network comprises that the first node has established an RRC connection with the first network, but has not yet transmitted a UECapabilityInformation message.

In one embodiment, the meaning of the sentence that the first node transmits no capability information to the first network comprises that the action of being in communication with the second network occurs before the first node establishes an RRC connection with the first network.

In one embodiment, the meaning of the sentence that the first node transmits no capability information to the first network comprises that the action of being in communication with the second network occurs after the first node establishes an RRC connection with the first network and that the action of being in communication with the second network occurs before the first node transmits capability information relating to the first network.

In one embodiment, the meaning of the sentence that the first node transmits no capability information to the first network comprises that the action of being in communication with the second network occurs after the first node establishes an RRC connection with the first network and that the action of being in communication with the second network occurs before the first node transmits UECapabilityInformation.

In one embodiment, the meaning of the sentence that a capability indicated by the capability information transmitted to the first network from the first node does not include the capability of being in communication with the second network comprises: an RRC connection is established between the first node and the first network, and the first node transmits UECapabilityInformation to the first network, but the capability indicated by the UECapabilityInformation transmitted by the first node is not required to be used for communication with the second network, i.e., the capability of being in communication with the second network is beyond the capability indicated by the UECapabilityInformation.

In one embodiment, the meaning of the sentence that a capability indicated by the capability information transmitted to the first network from the first node does not include the capability of being in communication with the second network comprises: an RRC connection is established between the first node and the first network, and the first node transmits UECapabilityInformation to the first network, the capability indicated by the UECapabilityInformation message including only a portion of capabilities of the first node.

In one embodiment, the meaning of the sentence that a capability indicated by the capability information transmitted to the first network from the first node does not include the capability of being in communication with the second network comprises: an RRC connection is established between the first node and the first network, and the first node transmits UECapabilityInformation to the first network, the capability indicated by the UECapabilityInformation message including only a capability of the first node of being in communication with the first network.

In one embodiment, the meaning of the sentence that a capability indicated by the capability information transmitted to the first network from the first node does not include the capability of being in communication with the second network comprises: an RRC connection is established between the first node and the first network, and the first node transmits UECapabilityInformation to the first network, the capability indicated by the UECapabilityInformation message including only a capability of the first node of being in communication with the first network as indicated by the first message.

In one embodiment, the meaning of the sentence that a capability indicated by the capability information transmitted to the first network from the first node does not include the capability of being in communication with the second network comprises: an RRC connection is established between the first node and the first network, and the first node transmits UECapabilityInformation to the first network, the UECapabilityInformation includes only the capability for communication with the first network, and the communication with the second network does not use or occupy the capability of being in communication with the first network.

In one embodiment, the meaning of the sentence that a capability indicated by the capability information transmitted to the first network from the first node does not include the capability of being in communication with the second network comprises: an RRC connection is established between the first node and the first network, and the first node transmits UECapabilityInformation to the first network, the UECapabilityInformation includes only the capability for communication with the first network, considering the capability required for communication with the second network.

In one embodiment, the meaning of the sentence that a capability indicated by the capability information transmitted to the first network from the first node does not include the capability of being in communication with the second network comprises: the capability indicated by the capability information transmitted by the first node to the first network is only used for communication with the first network.

In one embodiment, the sentence when none of conditions in the first condition set is satisfied means that any condition in the first condition set is not satisfied.

In one embodiment, that the first condition is not satisfied means that the first node establishes an RRC connection with the first network.

In one embodiment, that the second condition is not satisfied means that the first node has transmitted capability information to the first network.

In one subembodiment, the first node has transmitted capability information to the first network after a most recent RRC connection has been established.

In one subembodiment, the capability information comprises capability information indicated by UECapabilityInformation.

In one embodiment, that the third condition is not satisfied means that at least part of capabilities indicated by the capability information transmitted by the first node to the first network after the establishment of a most recent RRC connection is used for communication with the second network.

In one subembodiment, the capability information comprises capability information indicated by UECapabilityInformation.

In one embodiment, that the third condition is not satisfied means that the capability used by the first node for communication with the second network after the establishment of a most recent RRC connection belongs to the capabilities indicated by the capability information transmitted by the first node to the first network.

In one subembodiment, the capability information comprises capability information indicated by UECapabilityInformation.

In one embodiment, a first timer is started along with the first message.

In one embodiment, the first timer includes T346 in its name.

In one embodiment, the first timer includes mu-sim or musim in its name.

In one embodiment, the first timer is T346g.

In one embodiment, the first timer is T346h.

In one embodiment, the first timer is T346i.

In one embodiment, the first timer is T346j.

In one embodiment, the first timer is T346k.

In one embodiment, the first timer is T346m.

In one embodiment, when accessing the second network, stopping the first timer.

In one embodiment, as a response to accessing the second network, stopping the first timer.

In one embodiment, upon reception of an acknowledgment message for the first message, stopping the first timer.

In one embodiment, as a response to reception of an acknowledgment message for the first message, stopping the first timer.

In one embodiment, receiving an acknowledgment message for a first message, and as a response to receiving the acknowledgment message for the first message, stopping the first timer.

In one embodiment, receiving an acknowledgment message for a first message, and as a response to receiving the acknowledgment message for the first message, deactivating a secondary cell group (SCG); the acknowledgment message is used to indicate deactivation of the SCG.

In one embodiment, receiving an acknowledgment message for a first message, and as a response to receiving the acknowledgment message for the first message, suspending a radio bearer associated with an SCG.

In one embodiment, receiving an acknowledgment message for a first message, and as a response to receiving the acknowledgment message for the first message, resetting MAC for an SCG.

In one embodiment, receiving an acknowledgment message for a first message, and as a response to receiving the acknowledgment message for the first message, deactivating at least one SCell.

In one embodiment, receiving an acknowledgment message for a first message, and as a response to receiving the acknowledgment message for the first message, deactivating at least one SCell in a master cell group (MCG).

In one embodiment, the acknowledgment message for the first message is the first acknowledgment message.

In one embodiment, the action of being in communication with a second network occurs before the first node establishes an RRC connection with the first network.

In one embodiment, the action of being in communication with a second network occurs after the first node establishes an RRC connection with the first network.

In one embodiment, a first message indicates capabilities of wireless access technology of the first node and a capability of being in communication with a network other than the first network.

In one embodiment, a first message indicates capabilities of wireless access technology of the first node and capability/capabilities being occupied therein.

In one embodiment, a first message indicates capabilities of wireless access technology of the first node and capability/capabilities being reserved therein.

In one embodiment, a first message indicates capabilities of wireless access technology of the first node and capability/capabilities being unavailable therein.

In one embodiment, a first message indicates a capability category of the first node, the capability category of the first node being used to determine a capability of being in communication with the second network.

In one embodiment, a first message indicates a capability category of the first node, the capability category of the first node being used to determine a capability of being in communication with the first network.

In one embodiment, the first message is transmitted along with the action of being in communication with the second network, the action of being in communication with the second network being used to trigger the first message.

In one embodiment, the action of being in communication with the second network comprises receiving a paging message from the second network.

In one embodiment, the action of being in communication with the second network comprises receiving a paging message from the second network and determining to respond.

In one embodiment, the action of being in communication with the second network comprises determining to access the second network.

In one embodiment, as a response to receiving a paging of the second network, transmitting the first message.

In one embodiment, having determined to respond to a paging of the second network, transmitting the first message.

In one embodiment, as a response to determining to access the second network, transmitting the first message.

In one embodiment, as a response to determining to be in communication with the second network, transmitting the first message.

In one embodiment, whether the first message is used to indicate the capability of being in communication with a first network or the capability of being in communication with a network other than the first network is related to whether the first message is transmitted before the action of being in communication with the second network or is transmitted along with the action of being in communication with the second network; when the first message is transmitted before the action of being in communication with the second network, the first message indicates a capability required for communication with a network other than the first network; when the first message is transmitted along with the action of being in communication with the second network, the first message indicates the capability of being in communication with the first network.

In one subembodiment, the first message indicates, in an implicit manner, the capability of being in communication with a network other than the first network; the first message indicates, in an explicit manner, the capability of being in communication with the first network.

In one subembodiment, the first message indicates the capability of being in communication with a network other than the first network by indicating the release of some capabilities; the first message indicates the capability of being in communication with the first network by means of a capability entry or list.

In one subembodiment, when the first message is transmitted before the action of being in communication with a second network, the first message comprises only part of the first node's capabilities for a specific wireless access technology; when the first message is transmitted along with the action of being in communication with a second network, the first message comprises all of the first node's capabilities for a specific wireless access technology.

In one embodiment, the first message comprises UEAssistanceInformation when the first message is transmitted prior to the action of being in communication with the second network, and the first message comprises UECapabilityInformation when the first message is transmitted along with the action of being in communication with the second network.

In one embodiment, a signaling format used when the first message is transmitted prior to the action of being in communication with the second network is different from that used when the first message is transmitted along with the action of being in communication with the second network.

In one embodiment, the first message indicates a capability being occupied out of capabilities of the wireless access technology of the first node, the capability occupied out of the capabilities of the wireless access technology of the first node being determined by the capability of being in communication with the second network.

In one embodiment, the first message is used to indicate that the first node is in communication with a network other than the first network, that the first node is in communication with a network other than the first network indicated by the first message being used to indicate the capability of being in communication with a network other than the first network.

In one subembodiment, the capability used by the first node for communication with a network other than the first network is default.

In one subembodiment, the capability used by the first node for communication with a network other than the first network is pre-determined.

In one subembodiment, the sentence that the first node is in communication with a network other than the first network indicated by the first message being used to indicate the capability of being in communication with a network other than the first network means that: the first message indicates that the first node is in communication with a network other than the first network, and that the capability required or occupied by the first node for communication with a network other than the first network is agreed upon, and after the first network has received the first message, the first network indicates that the first node should release a corresponding capability.

In one subembodiment, the sentence that the first node is in communication with a network other than the first network indicated by the first message being used to indicate the capability of being in communication with a network other than the first network means that the first message indicates that the first node is in communication with a network other than the first network, and that the first network determines the capability of being in communication with a network other than the first network based on the communication with the network other than the first network as indicated by the first message.

In one subembodiment, the meaning of the sentence that the first message is used to indicate that the first node is in communication with a network other than the first network includes: the first message indicating a type of communication, such as voice communication or data communication, with a network other than the first network.

In one subembodiment, the meaning of the sentence that the first message is used to indicate that the first node is in communication with a network other than the first network includes: the first message indicating a QoS demand of communication with a network other than the first network.

In one subembodiment, the meaning of the sentence that the first message is used to indicate that the first node is in communication with a network other than the first network includes: the first message indicating resources occupied by communication with a network other than the first network.

In one subembodiment, the meaning of the sentence that the first message is used to indicate that the first node is in communication with a network other than the first network includes: the first message indicating a time length of communication with a network other than the first network.

In one subembodiment, the meaning of the sentence that the first message is used to indicate that the first node is in communication with a network other than the first network includes: the first message indicating a throughput of communication with a network other than the first network.

In one subembodiment, the meaning of the sentence that the first message is used to indicate that the first node is in communication with a network other than the first network includes: the first message indicating whether communication with a network other than the first network is an emergency communication.

In one subembodiment, the meaning of the sentence that the first message is used to indicate that the first node is in communication with a network other than the first network includes: the first message indicating a wireless access technology of communication with a network other than the first network.

In one subembodiment, the meaning of the sentence that the first message is used to indicate that the first node is in communication with a network other than the first network includes: the first message indicating a bandwidth and/or frequency of communication with a network other than the first network.

In one embodiment, the first message is used to request no use of capability/capabilities in a first capability set, the first capability set including at least one capability, the capability of being in communication with the second network including the first capability set.

In one subembodiment, the phrase no use of capability/capabilities in a first capability set includes: not supporting the use of an SCG.

In one subembodiment, the phrase no use of capability/capabilities in a first capability set includes: stopping the use of a cell group.

In one subembodiment, the phrase no use of capability/capabilities in a first capability set includes: de-activating a cell group.

In one subembodiment, the phrase no use of capability/capabilities in a first capability set includes: releasing a cell group.

In one subembodiment, the phrase no use of capability/capabilities in a first capability set includes: stopping the use of at least one SCell.

In one subembodiment, the phrase no use of capability/capabilities in a first capability set includes: de-activating at least one SCell.

In one subembodiment, the phrase no use of capability/capabilities in a first capability set includes: releasing at least one SCell.

In one subembodiment, the phrase no use of capability/capabilities in a first capability set includes: not using a specific frequency or carrier.

In one subembodiment, the communication with the first network occupies the capability/capabilities in the first capability set.

In one subembodiment, the communication with the first network does not occupy at least part of the capabilities in the first capability set.

In one embodiment, the first condition set comprises a fourth condition, the fourth condition being that the first node is in communication with the first network using a relay.

In one subembodiment, the fourth condition not being satisfied means that the first node does not use a relay for communication with the first network.

In one subembodiment, using a relay for communication with the first network means using an indirect path: not using a relay for communication with a network means using a direct path.

In one embodiment, the first message comprises any capability of the first capability set.

In one embodiment, the first message explicitly indicates whether any capability of the first capability set is supported.

In one embodiment, the first node establishes an RRC connection with the first network when transmitting the first message.

In one subembodiment, the first node has established an RRC connection with the second network.

In one subembodiment, the first node has not established an RRC connection with the second network.

In one embodiment, the first node establishes an RRC connection with the second network while in communication with the second network.

In one subembodiment, the first node has established an RRC connection with the first network.

In one subembodiment, the first node has not established an RRC connection with the first network.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application is the UE 201.

In one embodiment, the second node in the present application is the gNB 203.

In one embodiment, a radio link from the UE 201 to the NR Node B is an uplink.

In one embodiment, a radio link from the NR Node B to the UE 201 is a downlink.

In one embodiment, the UE 201 supports relay transmission.

In one embodiment, the UE 201 includes cellphone.

In one embodiment, the UE 201 is a means of transportation including automobile.

In one embodiment, the UE 201 supports multiple SIMs.

In one embodiment, the UE 201 supports sidelink transmission.

In one embodiment, the UE 201 supports MBS transmission.

In one embodiment, the UE 201 supports MBMS transmission.

In one embodiment, the gNB 203 is a base station.

In one embodiment, the gNB 203 is a flight platform.

In one embodiment, the gNB 203 is satellite equipment.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are: layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second node and the first node. The PC5 Signaling (PC5-S) Protocol sublayer 307 is responsible for the signaling protocol processing of the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC 306.

In one embodiment, the second message in the present application is generated by the RRC 306 or the MAC 302.

In one embodiment, the third message in the present application is generated by the RRC 306 or the MAC 302 or the PHY 301.

In one embodiment, the first request message in the present application is generated by the RRC 306 or the MAC 302.

In one embodiment, the first capability enquiry message in the present application is generated by the RRC 306.

In one embodiment, the first acknowledgment message in the present application is generated by the RRC 306.

### Embodiment 4

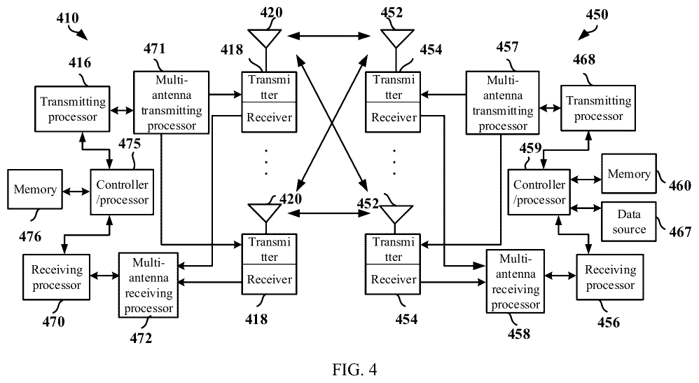

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, and optionally a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, and optionally a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer (Layer-2). In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450—targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first signaling, the first signaling indicating a first measurement gap set, with a first measurement gap being any measurement gap in the first measurement gap set; and performs a first operation set only outside of the first measurement gap; the first operation set is related to whether the first measurement gap belongs to a first-type measurement gap set or to a second-type measurement gap set; herein, the first-type measurement gap set includes at least one measurement gap; the second-type measurement gap set includes at least one measurement gap; any two adjacent measurement gaps in the first-type measurement gap set are equally spaced by a time interval that belongs to a first candidate time length set; the time lengths of the measurement gaps in the first-type measurement gap set are equal and belong to a second candidate time length set; the second-type measurement gap set comprises two adjacent measurement gaps between which the time interval does not belong to the first candidate time length set, or the second-type measurement gap set comprises a measurement gap of which the time length does not belong to the second candidate time length set; the first operation set comprises at least one of transmitting a HARQ feedback, transmitting an SR, transmitting a CSI, or reporting an SRS; the sentence that the first operation set is related to whether the first measurement gap belongs to a first-type measurement gap set or to a second-type measurement gap set means: when the first measurement gap belongs to the first-type measurement gap set, the first operation set does not include a first operation or a second operation or a third operation, the first operation is transmitting Msg3 on a UL-SCH, the second operation is transmitting MSGA on the UL-SCH, and the third operation is monitoring a PDCCH during the time while any timer of a first timer set is running; when the first measurement gap belongs to the second-type measurement gap set, the first operation set includes at least one of the first operation, the second operation or the third operation; the first timer set is used for random access.

In one embodiment, the first communication device 450 comprises a memory that stores a computer readable instruction program. The computer readable instruction program generates actions when executed by at least one processor. The actions include: receiving a first signaling, the first signaling indicating a first measurement gap set, with a first measurement gap being any measurement gap in the first measurement gap set; and performing a first operation set only outside of the first measurement gap; the first operation set is related to whether the first measurement gap belongs to a first-type measurement gap set or to a second-type measurement gap set; herein, the first-type measurement gap set includes at least one measurement gap; the second-type measurement gap set includes at least one measurement gap; any two adjacent measurement gaps in the first-type measurement gap set are equally spaced by a time interval that belongs to a first candidate time length set; the time lengths of the measurement gaps in the first-type measurement gap set are equal and belong to a second candidate time length set; the second-type measurement gap set comprises two adjacent measurement gaps between which the time interval does not belong to the first candidate time length set, or the second-type measurement gap set comprises a measurement gap of which the time length does not belong to the second candidate time length set; the first operation set comprises at least one of transmitting a HARQ feedback, transmitting an SR, transmitting a CSI, or reporting an SRS; the sentence that the first operation set is related to whether the first measurement gap belongs to a first-type measurement gap set or to a second-type measurement gap set means: when the first measurement gap belongs to the first-type measurement gap set, the first operation set does not include a first operation or a second operation or a third operation, the first operation is transmitting Msg3 on a UL-SCH, the second operation is transmitting MSGA on the UL-SCH, and the third operation is monitoring a PDCCH during the time while any timer of a first timer set is running; when the first measurement gap belongs to the second-type measurement gap set, the first operation set includes at least one of the first operation, the second operation or the third operation; the first timer set is used for random access.

In one embodiment, the first communication device 450 corresponds to the first node in the present application.

In one embodiment, the first communication device 450 is a UE.

In one embodiment, the first communication device 450 is a vehicle-mounted terminal.

In one embodiment, the second communication device 450 is a relay.

In one embodiment, the second communication device 450 is a satellite.

In one embodiment, the second communication device 450 is an aircraft.

In one embodiment, the second communication device 410 is a base station.

In one embodiment, the second communication device 410 is a relay.

In one embodiment, the second communication device 410 is a satellite.

In one embodiment, the second communication device 410 is an aircraft.

In one embodiment, the receiver 454 (comprising the antenna 452), the receiving processor 456 and the controller/processor 459 are used for receiving the first capability enquiry message in the present application.

In one embodiment, the receiver 454 (comprising the antenna 452), the receiving processor 456 and the controller/processor 459 are used for receiving the first acknowledgment message in the present application.

In one embodiment, the transmitter 454 (comprising the antenna 452), the transmitting processor 468 and the controller/processor 459 are used for transmitting the first request message in the present application.

In one embodiment, the transmitter 454 (comprising the antenna 452), the transmitting processor 468 and the controller/processor 459 are used for transmitting the first message in the present application.

In one embodiment, the transmitter 454 (comprising the antenna 452), the transmitting processor 468 and the controller/processor 459 are used for transmitting the second message in the present application.

In one embodiment, the transmitter 454 (comprising the antenna 452), the transmitting processor 468 and the controller/processor 459 are used for transmitting the third message in the present application.

### Embodiment 5

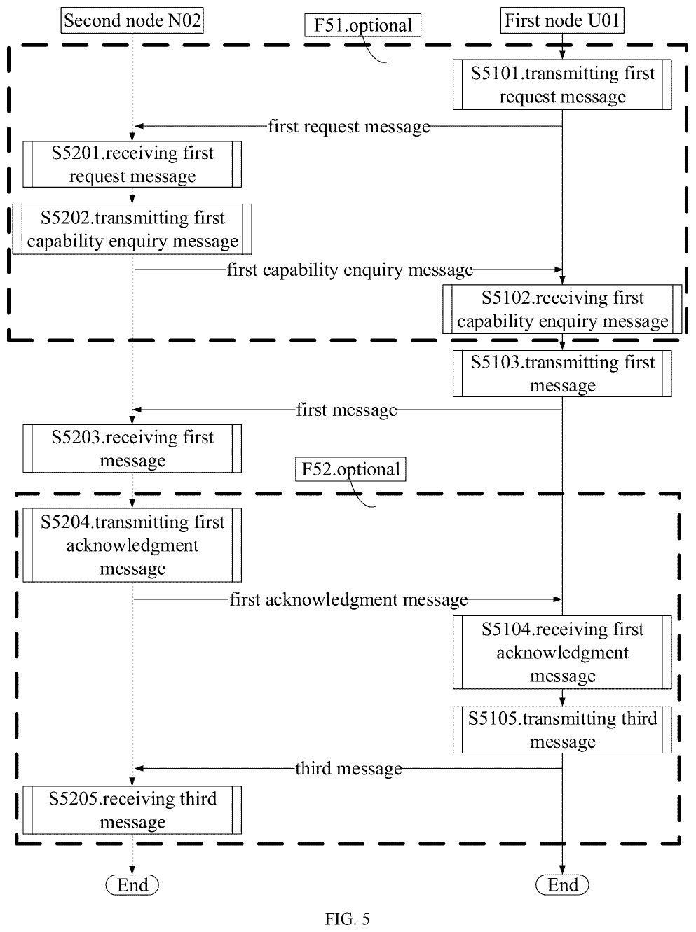

Embodiment 5 illustrates a flowchart of radio signal transmission according to one embodiment of the present application, as shown in FIG. 5. In FIG. 5, U01 corresponds to the first node in the present application. It should be particularly noted that the sequence illustrated herein does not set any limit on the orders in which signals are transmitted and implementations in this present application. Herein, steps in F51 and F52 are optional.

The first node U01 transmits a first request message in step S5101; receives a first capability enquiry message in step S5102; transmits a first message in step S5103; receives a first acknowledgment message in step S5104; and transmits a third message in step S5105.

The second node N02 receives the first request message in step S5201; transmits the first capability enquiry message in step S5202; receives the first message in step S5203; transmits the first acknowledgment message in step S5204; and receives the third message in step S5205.

In Embodiment 5, the first message is used to indicate at least one of a capability of being in communication with a first network or a capability of being in communication with a network other than the first network; the first message being for the first network;
the first node U01 is in communication with a second network;
herein, whether the first message is transmitted before the action of being in communication with the second network or is transmitted along with the action of being in communication with the second network is related to whether any condition in a first condition set is satisfied; the first condition set includes at least one of a first condition, a second condition or a third condition, the first condition being that the first node establishes no RRC connection with the first network, the second condition being that the first node transmits no capability information to the first network, and the third condition being that a capability indicated by the capability information transmitted to the first network from the first node does not include the capability of being in communication with the second network; the sentence whether the first message is transmitted before the action of being in communication with the second network or is transmitted along with the action of being in communication with the second network is related to whether any condition in a first condition set is satisfied, meaning: when any condition in the first condition set is satisfied, the first message is transmitted along with the action of being in communication with the second network; when none of conditions in the first condition set is satisfied, the first message is transmitted before the action of being in communication with the second network.

In one embodiment, the first node U01 is a UE.

In one embodiment, the first node U01 is a Remote U2N UE.

In one embodiment, the first node U01 is a relay.

In one embodiment, the second node N02 belongs to the first network.

In one embodiment, the second node N02 is a network.

In one embodiment, the second node N02 is a base station.

In one embodiment, the second node N02 is a relay.

In one embodiment, the second node N02 is a satellite.

In one embodiment, the second node N02 is an NTN.

In one embodiment, the second node N02 is a TN.

In one embodiment, the second node N02 is a serving cell of the first network of the first node U01.

In one embodiment, the second node N02 is a cell group of the first network of the first node U01.

In one embodiment, the second node N02 is a PCell of the first network of the first node U01.

In one embodiment, the second node N02 is an MCG of the first network of the first node U01.

In one embodiment, the second node N02 is a SpCell of the first network of the first node U01.

In one embodiment, the first node U01 has two SIMs, including a first SIM and a second SIM.

In one embodiment, the two SIMs of the first node U01 correspond to two different PLMNs.

In one embodiment, the first SIM is a SIM card for the second node N02; while the second SIM is a SIM card for nodes and networks other than the second node N02.

In one embodiment, the first SIM is a SIM card for the second node N02 or a network of the second node N02; the second SIM is a SIM card of a node other than the second node N02 or of a network other than the network of the second node N02.

In one embodiment, the first SIM is for the first network; while the second SIM is for the second network.

In one embodiment, there exists an RRC linkage between the first node U01 and the second node N02.

In one embodiment, multi-SIM in this application is denoted by MUSIM.

In one embodiment, the first message indicates a preference of the first node for the capability of being in communication with the first network.

In one embodiment, the first message indicates a preference of the first node for the capability of being in communication with a network other than the first network.

In one embodiment, the first request message is an RRC message.

In one embodiment, the first request message is used to trigger that the second node N02 transmits the first capability enquiry message.

In one embodiment, the first capability enquiry message comprises an RRC message.

In one embodiment, the first capability enquiry message is used to trigger the first message.

In one embodiment, the first capability enquiry message indicates that the capability to be inquired is for a specific wireless access technology.

In one embodiment, the first capability enquiry message indicates that the capability to be inquired is for a specific frequency or carrier.

In one embodiment, the first capability enquiry message indicates that the capability to be inquired is for the first network.

In one embodiment, the first capability enquiry message indicates that the capability to be inquired is for a network other than the first network.

In one embodiment, the first request message is used for multi-SIM communications.

In one embodiment, a name of the first request message includes request.

In one embodiment, the first request message includes UEAssistanceInformation.

In one embodiment, the first request message is used to request capability update.

In one subembodiment, the first node U01 updates a capability by transmitting the first message.

In one subembodiment, the capability update refers to a capability of being in communication with the first network.

In one subembodiment, the capability update refers to a capability of being in communication with a network other than the first network.

In one subembodiment, the capability update refers to a capability update of a wireless access technology.

In one subembodiment, the capability update includes an increase or decrease in capability.

In one subembodiment, the capability update includes the use or no use of a capability.

In one subembodiment, the capability update includes activation and de-activation of a capability.

In one subembodiment, the capability update includes the assignment of a capability.

In one embodiment, the first message is transmitted after having received the first capability enquiry message.

In one embodiment, the first capability enquiry message comprises a UEInformationRequest.

In one embodiment, the first capability enquiry message comprises UECapabilityEnquiry.

In one embodiment, the first message comprises UECapabilityInformation.

In one embodiment, steps within F51 and at least one step within F52 may co-exist.

In one embodiment, steps within F51 and at least one step within F52 do not coexist.

In one embodiment, the first acknowledgment message comprises an RRC message.

In one embodiment, the first acknowledgment message comprises an ACK from a physical layer or RLC.

In one embodiment, the first acknowledgment message comprises a MAC CE.

In one embodiment, the first acknowledgment message comprises a DCI.

In one embodiment, the first acknowledgment message comprises an RRCReconfiguration message.

In one embodiment, the first acknowledgment message is used for approving the first message.

In one subembodiment, the first acknowledgment message indicates the release of a capability requested to be released by the first message.

In one subembodiment, the first acknowledgment message indicates no use of a capability requested to be discontinued by the first message.

In one subembodiment, the first acknowledgment message indicates no use of the capability of being in communication with a network other than the first network indicated by the first message.

In one subembodiment, the first acknowledgment message indicates a configuration that does not occupy or no longer occupies the capability of being in communication with a network other than the first network indicated by the first message.

In one subembodiment, the meaning of the sentence that the first acknowledgment message is used for approving the first message comprises: the first message being used to confirm the first message.

In one subembodiment, as a response to receiving the first acknowledgment message, the first node U01 initiates communication with the second network.

In one embodiment, the third message is associated with the first message.

In one embodiment, the third message comprises an RRC message.

In one embodiment, the third message comprises a MAC CE.

In one embodiment, the third message comprises a physical-layer signaling.

In one embodiment, the third message comprises UECapabilityInformation.

In one embodiment, a name of the third message includes complete.

In one embodiment, the first node U01, after transmitting the third message, receives a fourth message, the fourth message being used to configure communication with the first network, the configuration indicated by the fourth message occupying the capability indicated by the first message for communication with a network other than the first network.

In one embodiment, the first node U01, after transmitting the third message, receives a fourth message, the fourth message being used to configure communication with the first network, the configuration indicated by the fourth message occupying the capability required for communication with the second network.

In one embodiment, the first node U01's communication with the second network may occur before the step S5103 or after the step S5103.

### Embodiment 6

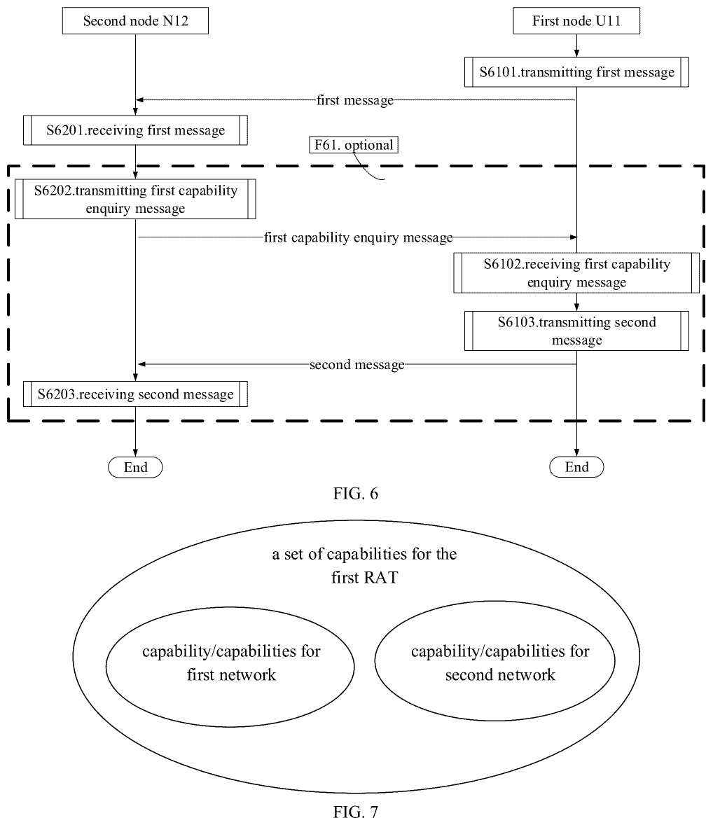

Embodiment 6 illustrates a flowchart of radio signal transmission according to one embodiment of the present application, as shown in FIG. 6. In FIG. 6, U11 corresponds to the first node in the present application. It should be particularly noted that the sequence illustrated herein does not set any limit on the orders in which signals are transmitted and implementations in this present application. Herein, steps in F61 are optional. With Embodiment 5 as the foundation, the content necessary but not explained in Embodiment 6 can refer to Embodiment 5.

The first node U11 transmits a first message in step S6101; receives a first capability enquiry message in step S6102; and transmits a second message in step S5103.

The second node N12 receives a first message in step S6201; transmits a first capability enquiry message in step S6202; and receives a second message in step S6203.

In one embodiment, the first node U11 is a UE.

In one embodiment, the first node U11 is a Remote U2N UE.

In one embodiment, the first node U11 is a relay.

In one embodiment, the second node N12 belongs to the first network.

In one embodiment, the second node N12 is a network.

In one embodiment, the second node N12 is a base station.

In one embodiment, the second node N12 is a relay.

In one embodiment, the second node N12 is a satellite.

In one embodiment, the second node N12 is an NTN.

In one embodiment, the second node N12 is a TN.

In one embodiment, the second node N12 is a serving cell of the first network of the first node U11.

In one embodiment, the second node N12 is a cell group of the first network of the first node U11.

In one embodiment, the second node N12 is a PCell of the first network of the first node U11.

In one embodiment, the second node N12 is an MCG of the first network of the first node U11.

In one embodiment, the second node N12 is a SpCell of the first network of the first node U11.

In one embodiment, the first node U11 has two SIMs, including a first SIM and a second SIM.

In one embodiment, the two SIMs of the first node U11 correspond to two different PLMNs.

In one subembodiment, the two PLMNs corresponding to the two SIMs respectively correspond to the first network and the second network.

In one embodiment, the first message is used to trigger the first capability enquiry message.

In one embodiment, the first message and the first capability enquiry message are independent of each other.

In one embodiment, the first message comprises a capability of wireless access technology of the first node U11 targeting the first network.

In one embodiment, the first message comprises a capability of wireless access technology of the first node U11 targeting the second network.

In one embodiment, the first message is ULInformationTransfer.

In one embodiment, the first message is UEAssistanceInformation or includes at least part of fields of UEAssistanceInformation.

In one embodiment, the first message is UECapabilityInformation.

In one embodiment, the first message is ULInformationTransferMRDC.

In one embodiment, the first message is SCGFailureInformation.

In one embodiment, the first message indicates the capability of being in communication with a network other than the first network by indicating that a failure has occurred.

In one subembodiment, the first message indicates that a configuration or link related to the capability of being in communication with a network other than the first network has failed or been unavailable.

In one subembodiment, the first message indicates that a post-bearer cell group or cell or path related to the capability of being in communication with a network other than the first network has failed or been unavailable.

In one embodiment, the UECapabilityInformation transmitted by the first node U11 to the second node N12 after the occurrence of the first message and before the end of the communication with the second network is different in content from the UECapabilityInformation message transmitted by the first node U11 to the second node N12 before the first message is transmitted.

In one embodiment, the UECapabilityInformation transmitted by the first node U11 to the second node N12 after the occurrence of the first message and before the end of the communication with the second network is different in content from the UECapabilityInformation message transmitted by the first node U11 to the second node N12 after the end of communication with the second network.

In one embodiment, as a response to the end of communication with the second network, the first node U11 transmits a third message; the third message being used to indicate the end of communication with a network other than the first network.

In one embodiment, as a response to the end of communication with the second network, the first node U11 transmits a third message; the third message being used to indicate recovery of the capability of being in communication with the first network.

In one embodiment, as a response to the end of communication with the second network, the first node U11 transmits a third message; the third message being used to indicate the capability of being in communication with the first network.

In one subembodiment, the capability of being in communication with the first network indicated by the third message is different from the capability of being in communication with the first network indicated by the first message.

In one embodiment, the UECapabilityInformation transmitted by the first node U11 to the second node N12 after the occurrence of the first message and before the transmission of the third message is different in content from the UECapabilityInformation message transmitted by the first node U11 to the second node N12 before the first message is transmitted.

In one embodiment, the UECapabilityInformation transmitted by the first node U11 to the second node N12 after the occurrence of the first message and before the transmission of the third message is different in content from the UECapabilityInformation message transmitted by the first node U11 to the second node N12 after the third message is transmitted.

In one embodiment, the second message is an RRC message.

In one embodiment, the second message is UECapabilityInformation.

In one embodiment, the second message is or includes UEAssistanceInformation.

In one embodiment, whether or not the first node U11 is in communication with a network other than the first network is used to determine the content of the transmitted UECapabilityInformation, where the UECapabilityInformation is used to indicate the capability of the wireless access technology of the first node U11.

In one subembodiment, the action of transmitting is to transmit to the second node N12.

### Embodiment 7

Embodiment 7 illustrates a schematic diagram of the capabilities for a first network and a second network according to one embodiment of the present application, as shown in FIG. 7.

FIG. 7 illustrates a set of capabilities for a first RAT.

In one embodiment, the first RAT is NR.

In one embodiment, the first RAT is EUTRA.

In one embodiment, the first RAT is NTN.

In one embodiment, the first RAT is TN.

In one embodiment, the first RAT is Bluetooth.

In one embodiment, the first RAT is Sidelink communication technique.

In one embodiment, the first RAT is WIFI.

In one embodiment, the first message is used to indicate that capability/capabilities for the first RAT for communication with the first network is (are) capability/capabilities for the first network.

In one embodiment, the capability/capabilities for the first network includes/include at least one capability.

In one embodiment, the capability/capabilities for the first network includes/include an RF capability for communication with the first network.

In one embodiment, the capability/capabilities for the first network includes/include a number of transmitters in communication with the first network.

In one embodiment, the capability/capabilities for the first network includes/include a number of receivers in communication with the first network.

In one embodiment, the capability/capabilities for the first network includes/include a wireless access technology supported for communication with the first network.

In one embodiment, the capability/capabilities for the first network includes/include a frequency band supported for communication with the first network.

In one embodiment, the capability/capabilities for the first network includes/include a resource pool for sidelink communication supported by the first network.

In one embodiment, the capability/capabilities for the first network includes/include a number of cell groups supported for communication with the first network.

In one embodiment, the capability/capabilities for the first network includes/include whether a secondary cell group (SCG) is supported for communication with the first network.

In one embodiment, the capability/capabilities for the first network includes/include a number of RLC entities or RLC bearers or RLC paths for a radio bearer in communication with the first network.

In one embodiment, the capability/capabilities for the first network includes/include a processing capability of a baseband in communication with the first network.

In one embodiment, the capability/capabilities for the first network includes/include capability/capabilities or the number of CPUs in communication with the first network.

In one embodiment, the capability/capabilities for the first network includes/include a measurement gap supported for communication with the first network.

In one embodiment, the capability/capabilities for the first network includes/include whether power saving techniques are supported in communication with the first network.

In one embodiment, the capability/capabilities for the first network includes/include a number of antennas or an antenna configuration supported for communication with the first network.

In one embodiment, the capability/capabilities for the first network includes/include a reference signal configuration supported for communication with the first network.

In one embodiment, the first message is used to indicate that capability/capabilities for the first RAT for communication with the second network is (are) capability/capabilities for the second network.

In one embodiment, the capability/capabilities for the second network includes/include at least one capability.

In one embodiment, the capability/capabilities for the second network includes/include a resource pool for sidelink communication supported by the second network.

In one embodiment, the capability/capabilities for the second network includes/include an RF capability for communication with the second network.

In one embodiment, the capability/capabilities for the second network includes/include a number of transmitters in communication with the second network.

In one embodiment, the capability/capabilities for the second network includes/include a number of receivers in communication with the second network.

In one embodiment, the capability/capabilities for the second network includes/include a wireless access technology supported for communication with the second network.

In one embodiment, the capability/capabilities for the second network includes/include a frequency band supported for communication with the second network.

In one embodiment, the capability/capabilities for the second network includes/include a number of cell groups supported for communication with the second network.

In one embodiment, the capability/capabilities for the second network includes/include whether a secondary cell group (SCG) is supported for communication with the second network.

In one embodiment, the capability/capabilities for the second network includes/include a number of RLC entities or RLC bearers or RLC paths for a radio bearer in communication with the second network.

In one embodiment, the capability/capabilities for the second network includes/include a processing capability of a baseband in communication with the second network.

In one embodiment, the capability/capabilities for the second network includes/include capability/capabilities or a number of CPUs in communication with the second network.

In one embodiment, the capability/capabilities for the second network includes/include a measurement gap supported for communication with the second network.

In one embodiment, the capability/capabilities for the second network includes/include whether power saving techniques are supported in communication with the second network.

In one embodiment, the capability/capabilities for the second network includes/include a number of antennas or an antenna configuration supported for communication with the second network.

In one embodiment, the capability/capabilities for the second network includes/include a reference signal configuration supported for communication with the second network.

In one embodiment, a set of capabilities for the first RAT includes capability/capabilities for the first network and capability/capabilities for the second network.

In one embodiment, the capability/capabilities for the first network and capability/capabilities for the second network are different.

In one embodiment, the capability/capabilities for the first network and capability/capabilities for the second network are orthogonal.

In one embodiment, there is a non-empty intersection between the capability/capabilities for the first network and capability/capabilities for the second network.

In one embodiment, the union of the capability/capabilities for the first network and capability/capabilities for the second network is a set of capabilities for the first RAT.

In one embodiment, the first message indicates a set of capabilities for the first RAT.

In one embodiment, the first message indicates a set of capabilities for the first RAT and capability/capabilities for the first network, not including capability/capabilities for the second network.

In one embodiment, the first message indicates a set of capabilities for the first RAT and capability/capabilities for the second network, not including capability/capabilities for the first network.

In one embodiment, the first message indicates that the capability/capabilities for the first network also include capability/capabilities for the second network.

### Embodiment 8

Embodiment 8 illustrates a schematic diagram of the capabilities for a first network and a second network according to one embodiment of the present application, as shown in FIG. 8.

FIG. 8 illustrates capabilities for a first network and for a second network, the capability for the first network being a capability of being in communication with the first network, and the capability for the second network being a capability of being in communication with the second network.

In one embodiment, the capability for the first network includes a set of RATs used in communication with the first network, i.e. the first RAT set shown in the attached FIG. 8.

In one embodiment, the capability for the second network includes a set of RATs used in communication with the second network, i.e. the second RAT set shown in the attached FIG. 8.

In one embodiment, the first RAT set comprises NR.

In one embodiment, the first RAT set comprises EUTRA.

In one embodiment, the first RAT set comprises NTN.

In one embodiment, the first RAT set comprises TN.

In one embodiment, the first RAT set comprises Bluetooth.

In one embodiment, the first RAT set comprises Sidelink communication technique.

In one embodiment, the first RAT set comprises WIFI.

In one embodiment, the second RAT set comprises NR.

In one embodiment, the second RAT set comprises EUTRA.

In one embodiment, the second RAT set comprises NTN.

In one embodiment, the second RAT set comprises TN.

In one embodiment, the second RAT set comprises Bluetooth.

In one embodiment, the second RAT set comprises Sidelink communication technique.

In one embodiment, the second RAT set comprises WIFI.

In one embodiment, the first RAT set and the second RAT set are orthogonal.

### Embodiment 9

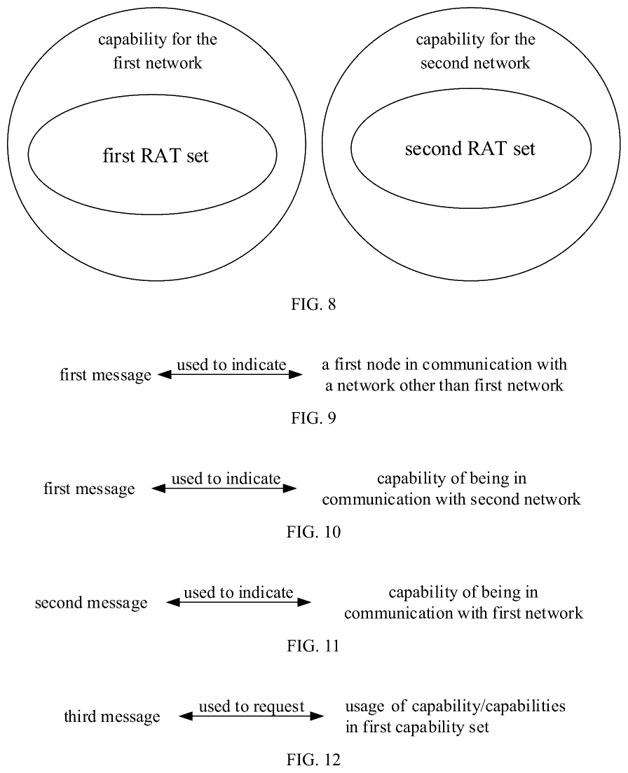

Embodiment 9 illustrates a schematic diagram of a first message being used to indicate a first node in communication with a network other than a first network according to one embodiment of the present application, as shown in FIG. 9.

In one embodiment, the first message explicitly indicates that the first node is in communication with a network other than the first network.

In one embodiment, a field of the first message indicates that the first node is in communication with a network other than the first network.

In one embodiment, the first message indicates an identity of a network other than the first network with which the first node is in communication.

In one embodiment, the first message indicates a type of a network other than the first network with which the first node is in communication.

In one embodiment, the first message indicates a QoS demand of the first node's communication with a network other than the first network.

In one embodiment, the first message indicates a service type of the first node's communication with a network other than the first network.

In one embodiment, the first message indicates a protocol and, or a version of protocols of a network other than the first network with which the first node is in communication.

In one embodiment, the first message indicates a wireless access technology of a network other than the first network with which the first node is in communication.

In one embodiment, the first message indicates a length of time for the first node's communication with a network other than the first network.

In one embodiment, the first message indicates a start time for the first node's communication with a network other than the first network.

In one embodiment, the first message indicates an end time for the first node's communication with a network other than the first network.

### Embodiment 10

Embodiment 10 illustrates a schematic diagram of a first message being used to indicate a capability of being in communication with a second network according to one embodiment of the present application, as shown in FIG. 10.

In one embodiment, the first message indicates a list of capabilities for communication with the second network.

In one embodiment, the first message indicates a QoS demand for communication with the second network.

In one subembodiment, the QoS demand may determine a required capability.

In one embodiment, the first message indicates a service or service type or service category in communication with the second network.

In one subembodiment, the service or service type or service category may determine a required capability.

In one embodiment, the first message indicates a capability requested to be released or not to be used, the capability requested to be released or not to be used being a capability of being in communication with the second network.

In one embodiment, the first message indicates a capability being reserved, the capability being reserved being a capability of being in communication with the second network.

In one embodiment, the first message indicates capabilities for one RAT and a capability of being in communication with the first network with respect to the first node, and the capability of being in communication with the second network is a capability other than the capability of being in communication with the first network among the capabilities for the one RAT.

In one embodiment, the capability of being communication with the second network is a capability other than the capability of being in communication with the first network.

In one embodiment, the first message indicates a UE category of the first node, the UE category being associated with or corresponding to a set of capabilities, and the capabilities corresponding to the UE category indicated by the first node that are not part of the capabilities used for communication with the first network being capabilities for communication with the second network.

In one embodiment, the first message indicates a UE category of the first node while in communication with the second network, the UE category being associated with or corresponding to a set of capabilities.

In one embodiment, the first message explicitly includes a list of capabilities or a table of capabilities for communication with the second network.

In one embodiment, the first message comprises a first index, the first index being associated with a list or table of capabilities.

In one embodiment, the first message indicates that capabilities for communication with the second network are for a first time window set, the first time window set comprising at least one time window.

In one subembodiment, the first node is in communication with the second network within the first time window set.

### Embodiment 11

Embodiment 11 illustrates a schematic diagram of a second message being used to indicate a capability of being in communication with a first network according to one embodiment of the present application, as shown in FIG. 11.

In one embodiment, the second message is an RRC message.

In one embodiment, the second message is transmitted via a relay.

In one embodiment, the second message is not transmitted via a relay.

In one embodiment, the second message is UEAssistanceInformation.

In one embodiment, the second message is UECapabilityInformation.

In one embodiment, the second message explicitly indicates a list of capabilities to communicate with the first network.

In one embodiment, the capabilities of the wireless access technology indicated by the second message are all capabilities for communication with the first network.

In one embodiment, the capabilities of the wireless access technology indicated by the second message are all available for communication with the first network.

In one embodiment, the second message indicates whether the capability to communicate with the first network has changed by indicating whether the capability of the wireless access technology of the first node has changed.

In one embodiment, the second message is transmitted after the first message has been transmitted and before the first node stops communication with the second network, the capability of the wireless access technology indicated by the second message differing from the capability of the wireless access technology indicated by the first message.

In one embodiment, the second message is transmitted after the first message has been transmitted and before the first node stops communication with the second network, the capability of the wireless access technology indicated by the second message being the same as the capability of the wireless access technology indicated by the first message, but different from the capability of the wireless access technology indicated by the UECapabilityInformation transmitted after communication with the second network has ceased.

In one embodiment, the capability of the wireless access technology indicated by the second message is related to whether or not the first node is in communication with the second network.

In one embodiment, the second message indicates a capability that may be used for communication with the first network.

### Embodiment 12

Embodiment 12 illustrates a schematic diagram of a third message being used to request usage of capability/capabilities in a first capability set according to one embodiment of the present application, as shown in FIG. 12.

In one embodiment, the capability of being in communication with the second network includes the first capability set.

In one embodiment, the third message indicates at least one capability in the first capability set.

In one embodiment, the third message indicates all of the capabilities in the first capability set.

In one embodiment, the third message indicates the first capability set.

In one embodiment, the first message indicates the first capability set.

In one embodiment, the third message corresponds to the first message, and a capability set indicated by the third message is the capability of being in communication with a network other than the first network as indicated by the first message.

In one embodiment, the second message indicates the first capability set, and the second message includes a configuration index of the first capability set, the third message including the configuration index.

In one embodiment, the first message indicates the first capability set, and the first message includes a configuration index of the first capability set, the third message including the configuration index.

In one embodiment, the capabilities indicated by the third message are all required to be resumed.

In one embodiment, the phrase usage of capability/capabilities in a first capability set means: recovering the capability/capabilities in the first capability set.

In one embodiment, the phrase usage of capability/capabilities in a first capability set means: the capability/capabilities in the first capability set can be used for communication with the first network.

In one embodiment, the phrase usage of capability/capabilities in a first capability set means: the capability/capabilities in the first capability set will no longer be used for communication with a network other than the first network.

In one embodiment, along with transmission of the third message, the first node uses the capability/capabilities in the first capability set for communication with the first network.

In one embodiment, along with transmission of the third message, the first node activates the capability/capabilities in the first capability set.

In one subembodiment, the action of activating the capability/capabilities in the first capability set includes activating an SCG.

In one subembodiment, the action of activating the capability/capabilities in the first capability set includes activating an SCell.

In one subembodiment, the action of activating the capability/capabilities in the first capability set includes continuing a radio bearer.

In one subembodiment, the action of activating the capability/capabilities in the first capability set includes continuing a suspended transmission.

In one subembodiment, the action of activating the capability/capabilities in the first capability set includes continuing a RLC bearer.

In one subembodiment, the action of activating the capability/capabilities in the first capability set includes monitoring a specific physical channel.

In one subembodiment, the action of activating the capability/capabilities in the first capability set includes using the sidelink for transmission.

In one subembodiment, the action of activating the capability/capabilities in the first capability set includes using a specific resource pool, where a band occupied by the specific resource pool belongs to the first capability set.

In one embodiment, along with transmission of the third message, the first node stops the first timer.

### Embodiment 13

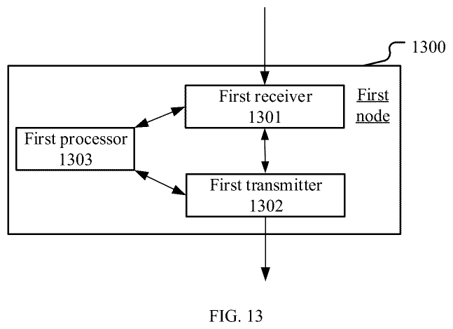

Embodiment 13 illustrates a structure block diagram of a processing device used in a first node according to one embodiment of the present application, as shown in FIG. 13. In FIG. 13, a processing device 1300 in the first node comprises a first receiver 1301, a first transmitter 1302 and a first processor 1303.

In Embodiment 13, the first transmitter 1302 transmits a first message; the first message being used to indicate at least one of a capability of being in communication with a first network or a capability of being in communication with a network other than the first network: the first message being for the first network;
the first processor 1303 is in communication with a second network;
herein, whether the first message is transmitted before the action of being in communication with the second network or is transmitted along with the action of being in communication with the second network is related to whether any condition in a first condition set is satisfied; the first condition set includes at least one of a first condition, a second condition or a third condition, the first condition being that the first node establishes no RRC connection with the first network, the second condition being that the first node transmits no capability information to the first network, and the third condition being that a capability indicated by the capability information transmitted to the first network from the first node does not include the capability of being in communication with the second network; the sentence whether the first message is transmitted before the action of being in communication with the second network or is transmitted along with the action of being in communication with the second network is related to whether any condition in a first condition set is satisfied, meaning: when any condition in the first condition set is satisfied, the first message is transmitted along with the action of being in communication with the second network; when none of conditions in the first condition set is satisfied, the first message is transmitted before the action of being in communication with the second network.

In one embodiment, the first message is transmitted along with the action of being in communication with the second network, the action of being in communication with the second network being used to trigger the first message.

In one embodiment, whether the first message is used to indicate the capability of being in communication with the first network or the capability of being in communication with a network other than the first network is related to whether the first message is transmitted before the action of being in communication with the second network or is transmitted along with the action of being in communication with the second network; when the first message is transmitted before the action of being in communication with the second network, the first message indicates a capability required for communication with a network other than the first network; when the first message is transmitted along with the action of being in communication with the second network, the first message indicates the capability of being in communication with the first network.

In one embodiment, the first message is used to indicate that the first node is in communication with a network other than the first network, that the first node is in communication with a network other than the first network indicated by the first message being used to indicate the capability of being in communication with a network other than the first network.

In one embodiment, the first transmitter 1302 transmits a first request message, the first request message being used to request capability update;
the first receiver 1301 receives a first capability enquiry message after the first request message is transmitted;
herein, the first capability enquiry message is used to trigger the first message.

In one embodiment, the first receiver 1301 receives a first capability enquiry message after the first message is transmitted;
the first transmitter 1302 transmits a second message as a response to receiving the first capability enquiry message;
herein, the first message is used to indicate the capability of being in communication with the second network, while the second message is used to indicate the capability of being in communication with the first network.

In one embodiment, the first message is used to request no use of capability/capabilities in a first capability set, the first capability set including at least one capability, the capability of being in communication with the second network including the first capability set.

In one embodiment, the first receiver 1301 receives a first acknowledgment message; the first acknowledgment message being used to approve the first message;
herein, the first message is transmitted before the action of being in communication with the second network, and reception of the first acknowledgment message is earlier than the action of being in communication with the second network.

In one embodiment, the first processor 1303 stops the communication with the second network;
the first transmitter 1302 transmits a third message as a response to the action of stopping the communication with the second network, the third message being used to request the use of the capability/capabilities in a first capability set.

In one embodiment, the first node is a UE.

In one embodiment, the first node is a terminal supporting large delay difference.

In one embodiment, the first node is a terminal supporting NTN.

In one embodiment, the first node is an aircraft or vessel.

In one embodiment, the first node is a cellphone or vehicle-mounted terminal.

In one embodiment, the first node is a relay UE and/or a U2N remote UE.

In one embodiment, the first node is an IoT terminal or IIoT terminal.

In one embodiment, the first node is a piece of equipment supporting transmissions with low delay and high reliability:

In one embodiment, the first node is a sidelink communication node.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment.

This disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transmitter, transmitting a first message; the first message being used to indicate at least one of a capability of being in communication with a first network or a capability of being in communication with a network other than the first network; the first message being for the first network; and
a first processor, being in communication with a second network;
wherein whether the first message is transmitted before the communication with the second network or is transmitted along with the communication with the second network is related to whether any condition in a first condition set is satisfied; the first condition set includes at least one of a first condition, a second condition or a third condition, the first condition being that the first node establishes no Radio Resource Control (RRC) connection with the first network, the second condition being that the first node transmits no capability information to the first network, and the third condition being that a capability indicated by the capability information transmitted to the first network from the first node does not include the capability of being in communication with the second network; whether the first message is transmitted before the communication with the second network or is transmitted along with the communication with the second network is related to whether any condition in a first condition set is satisfied, meaning: when any condition in the first condition set is satisfied, the first message is transmitted along with the communication with the second network; when none of conditions in the first condition set is satisfied, the first message is transmitted before the communication with the second network.

2. The first node according to claim 1, characterized in that
the first message is transmitted along with the communication with the second network, the communication with the second network being used to trigger the first message.

3. The first node according to claim 1, characterized in that
whether the first message is used to indicate the capability of being in communication with the first network or the capability of being in communication with a network other than the first network is related to whether the first message is transmitted before the communication with the second network or is transmitted along with the communication with the second network; when the first message is transmitted before the communication with the second network, the first message indicates a capability required for communication with a network other than the first network; when the first message is transmitted along with the communication with the second network, the first message indicates the capability of being in communication with the first network.

4. The first node according to claim 2, characterized in that
whether the first message is used to indicate the capability of being in communication with the first network or the capability of being in communication with a network other than the first network is related to whether the first message is transmitted before the communication with the second network or is transmitted along with the communication with the second network; when the first message is transmitted before the communication with the second network, the first message indicates a capability required for communication with a network other than the first network; when the first message is transmitted along with the communication with the second network, the first message indicates the capability of being in communication with the first network.

5. The first node according to claim 1, characterized in that
the first message is used to indicate that the first node is in communication with a network other than the first network, wherein that the first node is in communication with a network other than the first network indicated by the first message is used to indicate the capability of being in communication with a network other than the first network.

6. The first node according to claim 1, characterized in comprising:
the first transmitter, transmitting a first request message, the first request message being used to request capability update; and
a first receiver, receiving a first capability enquiry message after the first request message is transmitted;
wherein the first capability enquiry message is used to trigger the first message.

7. The first node according to claim 1, characterized in comprising:
a first receiver, receiving a first capability enquiry message after the first message is transmitted; and
the first transmitter, transmitting a second message as a response to receiving the first capability enquiry message;
wherein the first message is used to indicate the capability of being in communication with the second network, while the second message is used to indicate the capability of being in communication with the first network.

8. The first node according to claim 1, characterized in that
the first message is used to request no use of capability/capabilities in a first capability set, the first capability set including at least one capability, the capability of being in communication with the second network including the first capability set.

9. The first node according to claim 1, characterized in comprising:
a first receiver, receiving a first acknowledgment message; the first acknowledgment message being used to approve the first message;
wherein the first message is transmitted before the communication with the second network, and reception of the first acknowledgment message is earlier than the communication with the second network.

10. The first node according to claim 8, characterized in comprising:
the first processor, stopping the communication with the second network; and
the first transmitter, transmitting a third message as a response to the stopping the communication with the second network, the third message being used to request the use of the capability/capabilities in a first capability set.

11. The first node according to claim 1, characterized in comprising:
the first transmitter, starting a first timer, along with the first message;
wherein reception of an acknowledgment message for the first message is used to stop the first timer.

12. The first node according to claim 11, characterized in that
the first message is transmitted only when the first timer is not running.

13. The first node according to claim 11, characterized in comprising:
the first processor, suspending at least part of radio bearer(s) as a response to the first timer being expired.

14. The first node according to claim 11, characterized in comprising:
the first processor, de-activating at least one serving cell or cell group as a response to the first timer being expired.

15. A method in a first node for wireless communications, comprising:
transmitting a first message; the first message being used to indicate at least one of a capability of being in communication with a first network or a capability of being in communication with a network other than the first network; the first message being for the first network; and
being in communication with a second network;
wherein whether the first message is transmitted before the communication with the second network or is transmitted along with the communication with the second network is related to whether any condition in a first condition set is satisfied; the first condition set includes at least one of a first condition, a second condition or a third condition, the first condition being that the first node establishes no RRC connection with the first network, the second condition being that the first node transmits no capability information to the first network, and the third condition being that a capability indicated by the capability information transmitted to the first network from the first node does not include the capability of being in communication with the second network; whether the first message is transmitted before the communication with the second network or is transmitted along with the communication with the second network is related to whether any condition in a first condition set is satisfied, meaning: when any condition in the first condition set is satisfied, the first message is transmitted along with the communication with the second network; when none of conditions in the first condition set is satisfied, the first message is transmitted before the communication with the second network.

16. The method in the first node according to claim 15, characterized in that
the first message is transmitted along with the communication with the second network, the communication with the second network being used to trigger the first message.

17. The method in the first node according to claim 16, characterized in that
whether the first message is used to indicate the capability of being in communication with the first network or the capability of being in communication with a network other than the first network is related to whether the first message is transmitted before the communication with the second network or is transmitted along with the communication with the second network; when the first message is transmitted before the communication with the second network, the first message indicates a capability required for communication with a network other than the first network; when the first message is transmitted along with the communication with the second network, the first message indicates the capability of being in communication with the first network.

18. The method in the first node according to claim 15, characterized in that
the first message is used to indicate that the first node is in communication with a network other than the first network, that the first node is in communication with a network other than the first network indicated by the first message being used to indicate the capability of being in communication with a network other than the first network.

19. The method in the first node according to claim 15, characterized in comprising:
starting a first timer, along with the first message;
wherein reception of an acknowledgment message for the first message is used to stop the first timer.

20. The method in the first node according to claim 19, characterized in comprising:
suspending at least part of radio bearer(s) as a response to the first timer being expired.
